(19) United States
(12) Patent Application Publication
(10) Pub. No.: US 2009/0243285 A1
(43) Pub. Date: Oct. 1, 2009

(54) DEVICE FOR SECURING HIGH-PRESSURE LINES TO A HIGH-PRESSURE RESERVOIR

(76) Inventor: Johann Warga, Bietigheim-Bissingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/295,668

(22) PCT Filed: Feb. 16, 2007
(86) PCT No.: PCT/EP2007/051493

§ 371 Date: Oct. 1, 2008

(30) Foreign Application Priority Data
Apr. 13, 2006 (DE) 102006017900.5

(51) Int. Cl. F16L 5/00

(52) U.S. Cl. 285/195

(57) ABSTRACT

The invention relates to a device for connecting a high-pressure line to a tubular high-pressure reservoir in the wall of which at least one connecting bore for the high-pressure line is configured. An end of the high-pressure line is covered by a half-shell of a shell-type securing device. The shell-type securing device encloses a peripheral surface of the high-pressure reservoir, the half-shells being braced against each other.

### PRIOR ART

German Patent Disclosure DE 199 48 341 A1 likewise relates to a high-pressure fuel reservoir, which is used in particular for a common rail fuel injection system of an internal combustion engine. The high-pressure fuel reservoir includes a tubular base, which is equipped with a plurality of connection openings. To increase the pressure level that the high-pressure fuel reservoir can be subjected to, at least two connection openings are disposed diametrically opposite one another in the tubular base body. Moreover, in the wall of the high-pressure fuel reservoir known from DE 199 48 341 A1, there are machining openings, which are each closed by closure stoppers.

German Patent Disclosure DE 199 48 338 A1 has as its subject a method for machining a high-pressure fuel reservoir, a high-pressure fuel reservoir, and a connection stub for application of the method. The high-pressure fuel reservoir includes a base body that is equipped with a plurality of connection openings. The region of the connection openings of the base body of the high-pressure fuel reservoir, to which high-pressure lines for the individual fuel injectors that are to be supplied with fuel and are at system pressure are connected, has through bores embodied in the wall, which have two portions with different inside diameters. For connecting the high-pressure lines that extend to the individual fuel injectors, fittings are screwed into the wall of the base body of the high-pressure fuel reservoir and these fittings in turn have a female thread for receiving a complementarily embodied connection end of a high-pressure line that extends to the fuel injector.

The high-pressure fuel reservoirs known from the prior art are predominantly embodied as forged components and made in one piece. As a rule, in the course of the metal-cutting machining the forging blanks are provided with the connection bores and equipped with the fittings that are required for connecting the high-pressure lines. Moreover, high-pressure fuel reservoirs are also embodied as multiple-piece welded components, which include a corresponding number of welded-on individual parts, such as the aforementioned fittings and tabs; a welded high-pressure fuel reservoir of this kind is actuated by means of the tabs in the cylinder head region of the internal combustion engine.

Both high-pressure fuel reservoirs made as forged components and welded high-pressure reservoirs made from a plurality of individual components entail very major production effort and expense.

### DISCLOSURE OF THE INVENTION

In view of the versions sketched above in the prior art, it is the object of the invention to furnish a high-pressure reservoir, in particular for high-pressure reservoir injection systems (common rails) for which the effort and expense of production and assembly are simplified considerably and in which the sealing between a given high-pressure line leading to the fuel injector and the corresponding connection bore in the high-pressure reservoir can already be achieved during the assembly.

According to the invention, this object is attained in that shell-like securing devices for the high-pressure lines leading to the fuel injectors are associated with the circumference of the high-pressure reservoir body in the region of the connection bores, and these securing devices cover the high-pressure lines in an upset region and in a positioning region and press them into a positioning region of the circumferential surface of the high-pressure reservoir body. The shell-like securing device preferably includes two half-shells that can be suspended one inside the other on one end and that on the other end are either braced against one another by a clamping element on the circumference of the high-pressure reservoir body, or are secured to the circumference of the high-pressure reservoir body with prestressing by way of the embodiment of a covering device between the open ends of the two half-shells. The shell-like securing device acts like a pipe clamp surrounding the circumference of the high-pressure reservoir body that is applied directly to the jacket face of the high-pressure reservoir body and generates the sealing force between the connection bore in the wall of the high-pressure reservoir body and the upset part at the end of the high-pressure line. The version proposed according to the invention avoids the use of fittings that are employed today, which in general are joined materially to the circumferential surface of the high-pressure reservoir body. Preferably, the two half-shells of the shell-like securing device are embodied as shaped sheet-metal pieces, which favorably affects the production costs.

The high-pressure reservoir body includes a simple tube, in which a number of connection bores are made; the number of connection bores made in the wall of the high-pressure reservoir body is equivalent to the number of fuel injectors of the engine that are to be supplied with fuel. As needed, securing tabs for fixing the high-pressure reservoir body in the cylinder head region of the engine can be welded to the drawn, simply embodied tube that essentially represents the high-pressure reservoir body. The hammering, securing and sealing between the high-pressure lines extending to the fuel injectors is done in the assembly of the shell-like securing device. By way of the embodiment proposed according to the invention, the possibility exists of connecting the high-pressure lines to the individual fuel injectors, which are under system pressure and are to be supplied with fuel, in a way that is free of shear force and is sealed off on the high-pressure reservoir body.

In a way that is especially simple from the standpoint of assembly, the two half-shells of the shell-like securing device are suspended one inside the other on one end. The possibility exists of preassembling the half-shell of the shell-like securing device that closes the upset part at the end of the high-pressure line toward the fuel injector, and thus of embodying it directly on the end of the high-pressure line that is to be fixed to the jacket face of the high-pressure reservoir body. Preferably, the particular one of the half-shells that surrounds the upset part at the end of the high-pressure line is secured against torsion by means of a fixation to the jacket face of the high-pressure reservoir body, so that in the final assembly, and especially when the clamping force is generated, no shear force acts on the high-pressure line to the fuel injector. Besides the preassembly of the particular one of the half-shells that covers the upset part of the high-pressure line, this half-shell can also be provided as a separate component with an insertion slit and installed as a single part in the assembly of the high-pressure line in the region of the connection bore on the high-pressure reservoir body. For reasons of strength, the half-shell that is preassembled to the high-pressure line is the more-favorable variant. In the half-shell which covers the upset part at the end of high-pressure line, a spacer disk or spacer ring with a collarlike extension is preferably built in. By means of the spacer ring or spacer disk with the collarlike extension, production imprecisions can be compensated for, and the forces acting on the seal between the upset part face embodied with corresponding geometry on the jacket face of the high-pressure reservoir body can be compensated for and in particular distributed uniformly on the sealing circumference.

The clamping force at the open end between the two half-shells for fixing the shell-like device for securing a jacket face of the high-pressure reservoir body can on the one hand be generated by a screw connection and on the other brought about by a deformation between the open ends of the two half-shells for securing the sealing tension. If a set screw is used as the clamping element in the context of a screw connection, then it can be prestressed with a corresponding nut on the one hand, and on the other, for example in the lower of the two half-shells, an accumulation of material can be embodied by means of a reshaping of material, in which accumulation of material a female thread is made. The screwlike clamping element can then be screwed to the lower of the two half-shells, dispensing with a separate nut. Moreover, a threaded collar can be created on the lower of the two half-shells by reshaping, and the screwlike clamping element for generating a clamping force can be screwed into it.

If a deformation is embodied on the two open ends of the half-shells of the shell-like securing device on the jacket face of the high-pressure reservoir body, then this introduction point for the clamping force is preferably embodied such that the open ends of the half-shells cover one another at this introduction point for the clamping force. As a result, the play at the introduction point of the clamping force into the securing device where the two half-shells are first suspended in or hooked on one another is forced out of the connection, so that a solid seat of the shell-like securing device on the jacket face of the high-pressure reservoir body is the result.

To assure a shear-force-free fixation of the high-pressure lines to the jacket face of the high-pressure reservoir even during the assembly of the shell-like securing device on the jacket face of the high-pressure reservoir body, a recess is preferably made on the jacket face of the high-pressure reservoir body. This recess cooperates with a protrusion that is embodied on either the upper half-shell or the lower half-shell. The combination of a protrusion embodied on one of the half-shells and the recess on the jacket face of the high-pressure reservoir body brings about a torsional fixation of the shell-like securing device during the assembly on the jacket face and of the high-pressure reservoir body and in particular upon generation of the prestressing, whether by means of a screw connection or by means of a deformation of the still-open ends of the two half-shells to be prestressed against one another.

### DRAWINGS

The invention is described in further detail below in conjunction with the drawings.

Shown are:

FIG. 1, a top view on a first variant embodiment of a shell-like securing device for a high-pressure line on the jacket face of a high-pressure reservoir body;

FIG. 2, a cross section through the variant embodiment shown in FIG. 1 of a shell-like securing device for a high-pressure line on the jacket face of a high-pressure reservoir body;

FIG. 3, a view from below of the first variant embodiment, shown in FIGS. 1 and 2, of the shell-like device for securing a high-pressure line on the jacket face of a high-pressure reservoir body;

FIG. 4, a section through a further variant embodiment of a shell-like device for securing a high-pressure line on the jacket face of a high-pressure reservoir body;

FIG. 5, a view from below of the second variant embodiment, shown in FIG. 4, of the shell-like device for securing a high-pressure line;

FIG. 5.1, a side view of the second variant embodiment, shown in FIG. 5, of the shell-like securing device;

FIG. 6, an elevation view of the second variant embodiment of the shell-like securing device from the top;

FIG. 7, a further, third variant embodiment of a shell-like securing device of a high-pressure line on the jacket face of a high-pressure reservoir body, with a clamping force introduction point that is created by deformation of the open half-shell ends;

FIG. 8, a completed clamping force introduction point in the third variant embodiment, shown in FIG. 7, of the shell-like securing device;

FIG. 9, a top view on the further, third variant embodiment shown in FIG. 7, of the shell-like securing device;

FIG. 10, a further, fourth variant embodiment of the shell-like securing device between a high-pressure line and the jacket face of a high-pressure reservoir body; and

FIG. 11, a side view of the further, fourth variant embodiment, shown in FIG. 10, of the shell-like securing device between the high-pressure line and the tubular high-pressure reservoir body;

FIG. 12, a top view on the fourth variant embodiment, shown in FIG. 10, of the shell-like securing device;

FIG. 13, a further variant embodiment of the shell-like securing device in a sectional view;

FIG. 13.1, a side view of the variant embodiment shown in FIG. 13, with a covering device disposed above the axis of symmetry;

FIG. 13.2, a top view on the variant embodiment shown in FIG. 13; and

FIGS. 14.2 and 14.2, a further variant embodiment with shells of a shell-like securing device that are axially displaceable relative to one another and lockable.

### VARIANT EMBODIMENTS

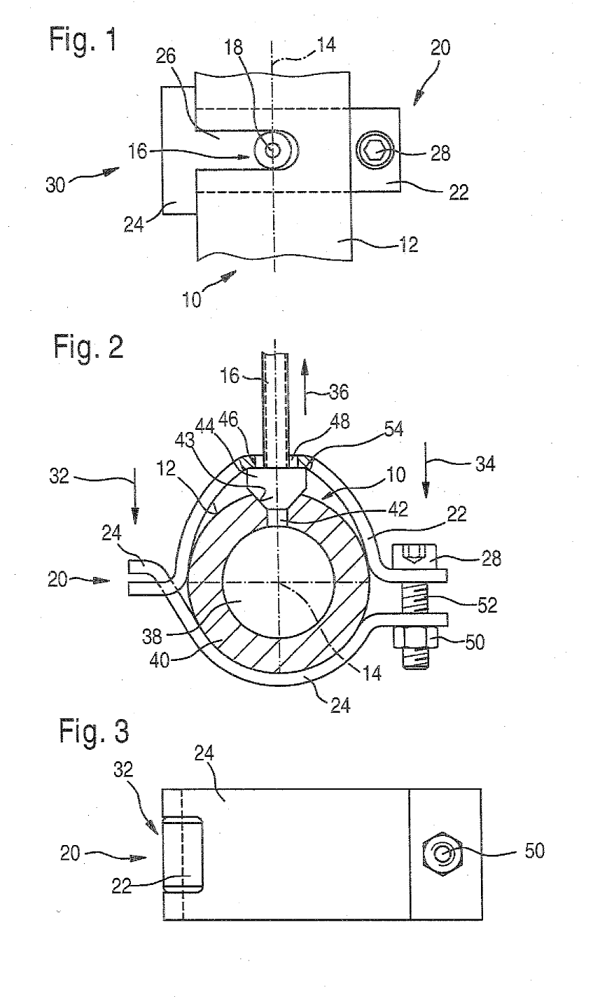

FIG. 1 shows a first variant embodiment of a shell-like device for securing a high-pressure line on the jacket face of a high-pressure reservoir body, seen from above.

Below, a shell-like securing device 20 will be described, which has an upper shell 22 and a lower shell 24. The upper shell 22 and the lower shell 24 are designed as complementary to one another, so that the upper and lower shells 22, 24 enclose a jacket face of a tubular high-pressure reservoir body 10 over an angle of 180°. The term “half-shells” will be understood hereinafter to mean that the shell-like securing device 20 includes two shell-shaped components, which surround the tubular high-pressure reservoir body 10 even over greater or lesser wrap angles 98 and 100 as well. In the assembled state, the shell-like securing device 20 surrounds a jacket face 12 of the tubular high-pressure reservoir body 10, preferably along the entire circumference, aside from the connection point with a high-pressure line 16. Thus the half-shells can be embodied for instance such that the upper shell 22 also surrounds a jacket face 12 of the high-pressure reservoir body 10 over a greater angle than 180°, and consequently the lower shell 24 surrounds the jacket face 12 of the high-pressure reservoir body 10 over a lesser angle than 180°. It is understood that the dimensions with regard to the angle surrounded by the half-shells 22, 24 of the shell-like securing device 20 can also be vice versa.

A high-pressure reservoir body 10, which is essentially tubular, has a jacket face 12. The high-pressure reservoir body 10 is embodied with a wall thickness that holds up upon subjection of the high-pressure reservoir body 10 to a system pressure of between 1600 and 2000 bar. The system pressure is generated in the high-pressure reservoir body 10 by a high-pressure pumping assembly, such as a high-pressure pump, which is not shown in the drawings described below. The high-pressure reservoir body 10 is embodied symmetrically to an axis of symmetry 14. On the jacket face 12 of the high-pressure reservoir body 10, a high-pressure line 16, shown in section, is received; it has a flow cross section 18 and extends to a fuel injector, not shown in FIG. 1. By means of the high-pressure line 16, the fuel at high pressure that is stored in the hollow chamber of the high-pressure reservoir body 10 is carried to the fuel injector. The high-pressure line 16 shown in section in FIG. 1 is secured to the jacket face 12 of the high-pressure reservoir body 10 by means of a shell-like securing device 20. The shell-like securing device 20 includes an upper shell 22 and a lower shell 24, which are embodied essentially semicircularly. In the first variant embodiment of the shell-like securing device 20, shown in FIG. 1, a slitlike recess 26 extends in the upper shell 22. The slitlike recess 26 in the upper shell 22 assures that the upper shell 22, in its assembly as a separate component, can be slipped over an upset part 44 not shown in FIG. 1 (see the view in FIG. 2), or in other words covers it. A first connection of the upper shell 22 to the lower shell 24 is provided by a clamp 30, at which the upper shell 22 is suspended from the lower shell 24. Diametrically opposite the clamp 30 is a clamping element 28, for instance in the form of a screw, by way of which the upper shell 22 and the lower shell 24 of the shell-like securing device 20 can be prestressed against one another. The upper shell 22 can be a component of the high-pressure line 16 and accordingly preassembled with it. In that case, the embodiment of the slitlike recess 26 on the upper shell 22 is dispensed with. The upper shell 22 of the shell-like securing device 20 can equally well be a separate component, which is slipped with the slitlike recess 26 over the aforementioned upset part of the high-pressure line 16 in the process of being mounted on the high-pressure reservoir body 10.

FIG. 2 shows a sectional view of the first variant embodiment, shown in FIG. 1, of a shell-like device for securing a high-pressure line 16 on the jacket face of a high-pressure reservoir body.

As can be seen from the view in FIG. 2, a wall 40 of the high-pressure reservoir body 10 surrounds a hollow chamber 38. The hollow chamber 38 is subjected to system pressure, and this pressure level is in the range between 1600 and 2000 bar. In the wall 40 of the high-pressure reservoir body 10, a number of connection bores 42 are made, corresponding to the number of fuel injectors to be connected to the high-pressure reservoir body. As can be seen from FIG. 2, the connection bores 42 discharge into funnel-shaped faces 43. Instead of a funnel-shaped configuration, the faces 43 may also be embodied hemispherically or with some other geometry.

The shell-like securing device 20, which includes the upper shell 22 and the lower shell 24, is fixed to the jacket face 12 of the high-pressure reservoir body 10. The upper shell 22 and the lower shell 24 are suspended in one another or hooked to one another at a first introduction point 32 for introducing a clamping force F_{K}. This connection of the upper shell 22 to the lower shell 24 at the first introduction point is done without tools. At the second introduction point 34, diametrically opposite the first introduction point 32, for introducing the clamping force F_{K} into the shell-like securing device 20, a screwlike clamping element 28 extends between the ends of the upper shell 22 and of the lower shell 24. A threaded portion of the clamping element 28 is identified by reference numeral 52; a nut that is engaged by the clamping element 28 is identified by reference numeral 50. Depending on the tightening torque of the clamping element 28, tensing of the upper shell 22 takes place against the lower shell 24 of the shell-like securing device 20 around the jacket face 12 of the high-pressure reservoir body 10. Any play still present at the first introduction point 32 is forced out of the shell-like securing device 20 in the process. Depending on the defined tightening torque with which the clamping element 28 is tightened, the upper shell 22 of the shell-like securing device 20, in the region of an opening 46 embodied in the upper shell 22, places itself above a upset part 44, forming an annular gap 48 around a shoulder 54. The upset part 44, in the variant embodiment shown in FIG. 2, has a frustoconical appearance. The upset part 44 is preferably manufactured to be complementary to the geometry of the connection face 43, in which the connection bore 42 comes to an end in the wall 40.

Depending on the remaining axial length of the free threaded portion 52 between the ends of the upper shell 22 and lower shell 24, the clamping force F_{K} can be generated; the clamping force F_{K} introduced at the first introduction point 32 and the second introduction point 34 is preferably equivalent to the sealing force 36 (F_{D}) to be exerted. This assures that a leakproof connection is made between the upset part 44 and the connection face 43, embodied with a complementary geometry to it, on the jacket face 12 of the high-pressure reservoir body 10.

FIG. 3 shows the first variant embodiment of the shell-like securing device of the invention from below.

From FIG. 3, it can be seen that the clamping element 28 penetrates the nut 50, thereby tightening the lower shell 24 against the upper shell 22. When the upper shell 22 is braced against the lower shell 24 at the second force introduction point 34, any play that still exists at the first force introduction point 32 is forced out of the shell-like securing device 20.

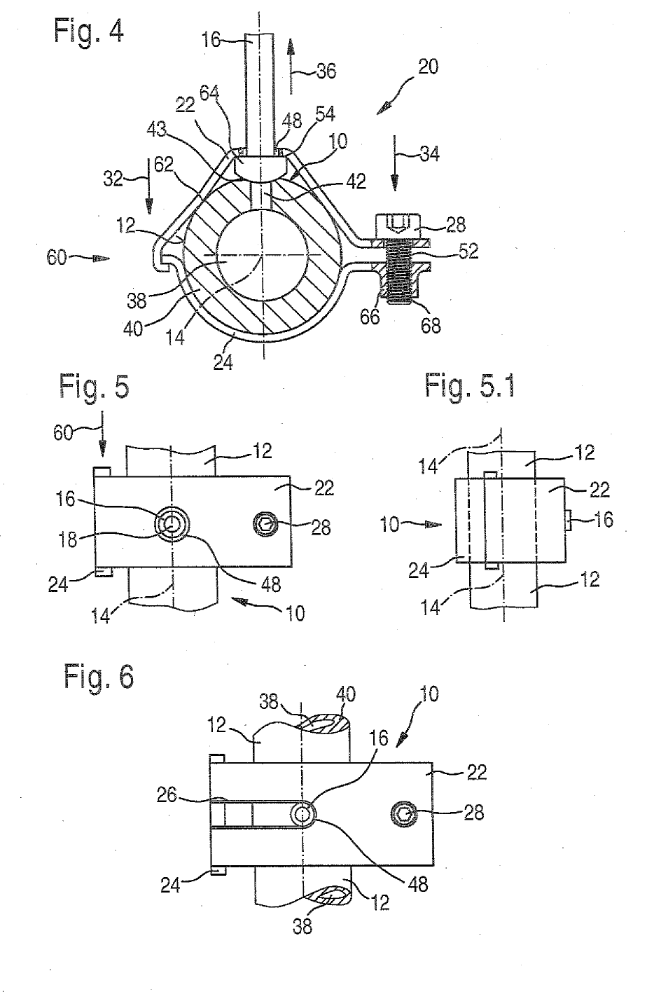

FIG. 4 shows a second variant embodiment of the shell-like securing device, with which a high-pressure line is connected in sealing fashion to the jacket face of the high-pressure reservoir.

It can be seen from the second variant embodiment shown in FIG. 4 that the upper shell 22 and the lower shell 24 are joined together by means of a covering device 60 at the first introduction point 32 of the clamping force F_{K}. In the variant embodiment shown in FIG. 4, a curved end of the upper shell 22 covers an extension of the lower shell 24 in the region of the first introduction point 32 of the clamping force F_{K}. At the second introduction point 34 of the clamping force F_{K}, the open ends of the upper shell 22 and lower shell 24 of the shell-like securing device 20 are screwed against one another via a clamping element 28. In this variant embodiment, in a distinction from the view in FIG. 2, the nut 50 can be dispensed with, since the female thread for the screwlike clamping element 28 is embodied in an accumulation of material 66. The female thread is identified by reference numeral 68. Unlike the sectional view shown in FIG. 2 of the first variant embodiment of the shell-like securing device, the high-pressure line 16 has a rounded upset part 64, which is positioned against the contact face 43 above the connection bore 42 in the wall 40 of the high-pressure reservoir body 10. The wall 40 defines the hollow chamber 38 of the high-pressure reservoir body 10, which chamber, via a high-pressure pumping assembly, not shown, is subjected to a system pressure of between 1600 and 2000 bar. The upper shell 22 includes the opening 46, through which the high-pressure line 16 extends. The upper half-shell 22 is thrust over the high-pressure line 16 before the rounded upset part 64 is made. The upper shell 22 rests on a shoulder 52, embodied on the rounded upset part 64, by way of which shoulder the sealing force between the high-pressure line 16 and the contact face 43 on the jacket face 12 of the high-pressure reservoir body 10 is generated in the prestressing of the upper shell 22 against the lower shell 24. The upper shell 22 can be provided with a flattened face 62, which cooperates with a correspondingly made flattened face on the jacket face 12 of the high-pressure reservoir body 10 and thus in the assembly acts as a torsion prevention means, so that the high-pressure line 16 can be mounted in a manner free of shear forces on the jacket face 12 of the high-pressure reservoir body 10.

FIG. 5 shows the second variant embodiment, shown in FIG. 4, of the tablike securing device from the top.

FIG. 5 shows that the upper shell 22 surrounds the lower shell 24 in the region of the covering device 30. The high-pressure line 16 is fixed, forming an annular gap 48, between the upper shell 22 and the outer circumferential surface of the high-pressure line 16. Because of the annular gap 48, shear forces cannot be introduced into the high-pressure line 16, which significantly extends the service life of the high-pressure line. In FIG. 5 in the top view, the clamping element 28 can be seen, which prestresses the upper shell 22 against the lower shell 24 in the region of the second force introduction point 34 for the clamping force F_{K}. For the sake of completeness, it is pointed out that the high-pressure reservoir body 10 is embodied substantially in tubular fashion and extends symmetrically to an axis of symmetry 14.

FIG. 5.1 shows a side view of the covering device, with which the upper shell and the lower shell of the shell-like securing device of FIG. 5 mesh with one another.

From the side view in FIG. 5.1, it can be seen that the covering device 60, as shown in FIG. 5, is produced without tools in the region of the first introduction point 32 for the clamping force F_{K}, and is created by means of a positive-engagement connection between the open ends of the upper shell 22 and the lower shell 24. The high-pressure line 16 is shown in part on the upper shell 22 for the sake of orientation.

From FIG. 6, the top view can be seen on the second variant embodiment, shown in section in FIG. 4, of the shell-like securing device of the high-pressure line to the jacket face of the high-pressure reservoir body.

From the view in FIG. 6, it can be seen the upper shell 22 includes the aforementioned slitlike recess 26. As a result, the upper shell 22 can be used as a separate component in the context of embodying the high-pressure connection between the high-pressure line 16 and the high-pressure reservoir body 10. In that case, the slitlike recess 26 allows the upper shell 22 to be slipped laterally onto the upset part 64, shown in further detail in FIG. 4 where it is rounded, on the end of the high-pressure line 16. As already noted, the upper shell 22 and the lower shell 24 of the shell-like securing device are suspended in one another or hooked on one another in the region of the first introduction point 32 for the clamping force F_{K}. The tension between the upper shell 22 and the lower shell 24 for fixing the shell-like securing device 20 to the jacket face 12 of the high-pressure reservoir 10 is defined essentially by the tightening torque of the clamping element 28. In the view in FIG. 6, it is indicated that the wall 40 of the high-pressure reservoir body 10 surrounds the hollow chamber 38 thereof. Below the high-pressure line 16 indicated in FIG. 6, the connection bore 42 shown in section in FIG. 4 is located in the wall 40 of the high-pressure reservoir body 10; it merges with the contact face 43, which in this case is funnel-shaped.

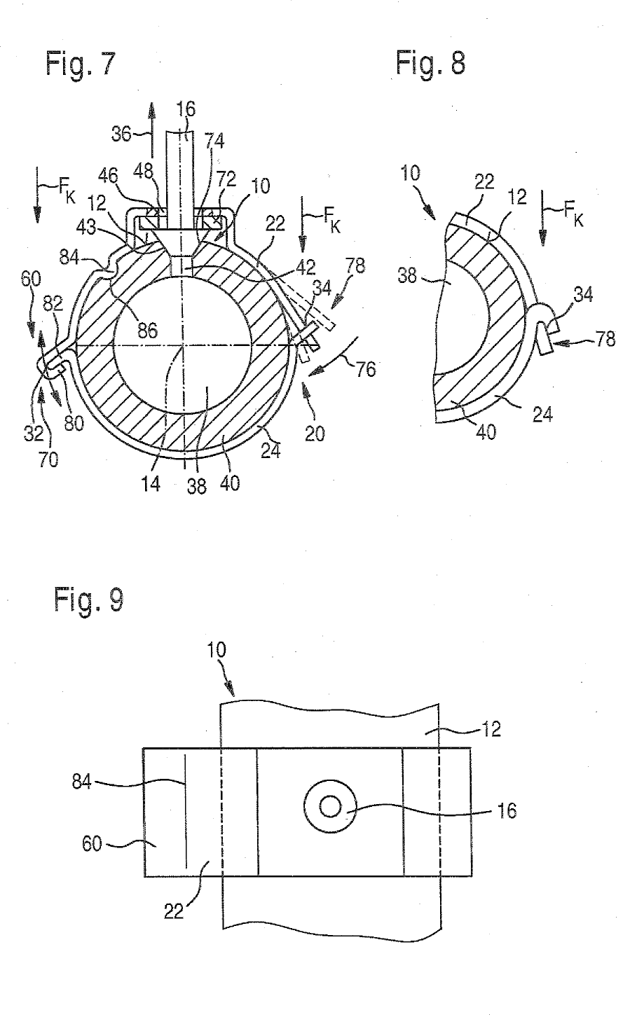

FIG. 7 shows a further, third variant embodiment of the shell-like device, proposed according to the invention, for securing a high-pressure line to the jacket face of the high-pressure reservoir body.

In the further, third variant embodiment, shown in FIG. 7, of the shell-like securing device 20, the jacket face 12 of the high-pressure reservoir body 10 is surrounded by the upper shell 22 and the lower shell 24 in the region of the connection bore 42. In the view in FIG. 7, a covering device 60 is embodied at the first introduction point 32 for introducing the clamping force F_{K}; a covering end 80 of the upper shell 22 surrounds a covering end 82 of the lower shell 24, forming a clamping element-free clamp 78. The double arrow indicates that the position of the covering device 60 can be embodied at arbitrary places on the jacket face 12, for instance at arbitrary angular positions relative to the axis of symmetry 14 of the high-pressure reservoir body 10. In the view in FIG. 7, the open end of the upper shell 22 is moved in the direction of a deformation path 26 at the second introduction point 34 diametrically opposite the first introduction point 32 of the clamping force F_{K}, and finally, the clamping element-free clamping 78 shown in FIG. 8 is generated at the second introduction point 34 of the clamping force F_{K}.

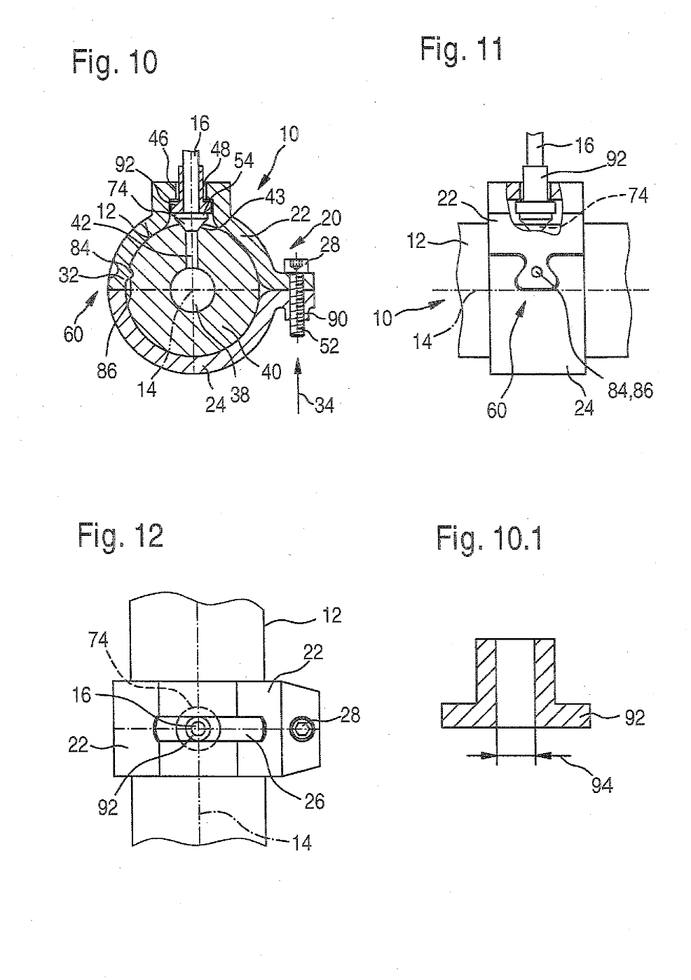

From the view in FIG. 7, it can furthermore be seen that the upper shell 22 has a domelike step, which in the view in FIG. 7 surrounds a spacer disk 72. Instead of the spacer disk 72 shown in FIG. 7, embodied without a sleevelike collar, the spacer disk 92 with a collar shown in FIG. 10.1 can also be used here, thus assuring that the high-pressure line 16 is secured to the jacket face 12 of the high-pressure reservoir body 10 and seated off in a manner free of shear force stress.

The spacer disk 72 shown in the view in FIG. 7 rests on the shoulder 54 of the upset part 74 of the high-pressure line 16. The upset part 74 has a conically configured jacket face, which is embodied as complementary to the funnel-shaped contact face 43 in the wall 40 of the high-pressure reservoir body 10.

A protrusion 84 is furthermore embodied on an inner side of the upper shell 22. The protrusion 84 protrudes into a recess 86 disposed in the jacket face 12 of the high-pressure reservoir 10. By the cooperation of the protrusion 84, embodied on the upper shell 22, with the recess 86 in the jacket face 12 of the high-pressure reservoir body 10, it is assured that the high-pressure reservoir body 10, in the making of the clamped connection at the second introduction point 34, will not rotate in relative fashion upon a deformation of the open end of the upper shell 22 corresponding to the deformation path 76, which would lead to a shear force stress on the high-pressure line 16. The high-pressure line 16 is protected against an introduction of shear stresses through the upper shell 22 by the spacer disk 72 on the one hand and by the annular gap 48 on the other. As an alternative to the spacer disk 72 shown in FIG. 7, the jacket face of the high-pressure line 16 can also be surrounded by the spacer disk 92 with a collar-like extension that is shown in section in FIG. 10.1.

FIG. 8 shows the connection of the upper shell 22 to the lower shell 24 in the region of the second introduction point of the clamping force.

From FIG. 8, it can be seen that upon deformation of the upper end of the upper shell 22 in the direction of the deformation path 76—as shown in FIG. 7—a clamping element-free clamping action 78 is created at the second introduction point 34 of the clamping force F_{K}. As a result, any play still present at the first introduction point 32 of the clamping force F_{K} is forced out of the shell-like securing device 20, on the one hand, and on the other, a contact over the full circumference of the insides of the upper shell 22 and of the lower shell 24 with the jacket face 12 of the high-pressure reservoir body 10 is achieved.

FIG. 9 shows the third variant embodiment, shown in FIG. 7, of the shell-like device for securing the high-pressure line to the jacket face of the high-pressure reservoir body, in a top view.

Reference numeral 84 indicates the location of the protrusion on the inner side of the upper shell 22; in collaboration with the recess 86 on the jacket face 12 of the high-pressure reservoir body 10, this protrusion serves as a torsion prevention means between the upper shell 22 and the high-pressure reservoir body 10 during assembly. The upper shell 10 and the lower shell 22 (not shown in FIG. 9) are joined together by the covering device 60, as shown in FIG. 7, in the region of the first introduction point 32 of the clamping force F_{K}.

FIG. 10 shows a further, fourth variant embodiment of the shell-like device for securing the high-pressure line 16 to the jacket face of the high-pressure reservoir body.

From the view in FIG. 10, it can be seen that in the region of the first introduction point 32 of the clamping force F_{K}, the open ends of the upper shell 22 and lower shell 24 can also be placed in one another in positive engagement, approximately in the form of a dovetail guide. The result is a clamping element-free clamping connection 78 in the region of the first introduction point 32 of the clamping force. In the region where the open ends of the upper shell 22 and lower shell 24 are joined together in the region of the first introduction point 32, the protrusion 84 can be embodied on the inner side pointing toward the jacket face 12 of the high-pressure reservoir body 10, and this protrusion engages the recess 86, embodied with corresponding geometry to it, of the jacket face 12 of the high-pressure reservoir body 10. In this way, in the variant embodiment shown in FIG. 10 as well, a relative motion between the tubular high-pressure reservoir body 10 and the shell-like securing device 20 surrounding it is precluded, so that an introduction of shear force into the high-pressure line 16 is prevented.

The opening 46 is embodied there. The annular gap 48 extends between the opening 46 and the jacket face of the high-pressure line 16. A spacer disk 92 with a collar-shaped extension is disposed below the upper shell 22 and surrounds the high-pressure line 16. The spacer disk 72 is braced on one side on the shoulder 54 of the upset part 74 having the conical surface and is surrounded on the other side by the upper shell 22. The collarlike extension of the spacer disk 92 shown in FIG. 10.1 protects the outer circumferential surface of the high-pressure line 16 against the introduction of shear forces and makes for more-uniform introduction of the prestressing force. It can also be seen from FIG. 10.1 that the spacer disk 92 with the collarlike extension has an inside diameter 94 that is essentially equivalent to the outside diameter of the high-pressure line 16. In the view in FIG. 10, the upset part 74, which has a frustoconical face, is forced into the funnel-shaped connection face 43 of the jacket face 12 above the connection bore 42 in the wall 40. This creates a leak-free connection among the hollow chamber 38 of the high-pressure reservoir body 10, the connection bore 42 in the wall 12 of the high-pressure reservoir body 10, and the high-pressure line 16.

In the variant embodiment shown in FIG. 10, the sealing force F_{D} (reference numeral 36) between the upper shell 22 and the lower shell 24 of the shell-like securing device 20 is generated via the clamping element 28. Also in the further, fourth variant embodiment shown in FIG. 10 of the shell-like securing device 20, a threaded collar 90, for instance, can be embodied in the lower shell 24 because the threaded portion 52 of the clamping element 28 is screwed in. Preferably, the upper shell 22 is preassembled on the high-pressure line 16, and as a result the formation of a T-shaped recess 26 in the upper shell 22, as shown in conjunction with the variant embodiments of FIGS. 1 and 6, can be dispensed with.

While in the further, fourth variant embodiment, shown in section in FIG. 10, of the shell-like securing device 20 the introduction of the clamping force F_{K} at the first introduction point 32 is effected by the ends, placed one inside the other, of the upper shell 22 and lower shell 24, the clamping force F_{K} at the second introduction point 24 is exerted by the clamping element 28. Preferably, the introduction of the clamping force F_{K} thus takes place at two locations on the jacket face 12 of the hog 10. Preferably, F_{D}=2F_{K}.

The variant embodiment shown in FIG. 10 of the shell-like securing device 20 is distinguished by the fact that in the region of the first introduction point 32 of the clamping force F_{K}, the connection 60 does not protrude in raised fashion radially past the upper shell 22 or the lower shell 24, as is the case for instance for the covering device 60 shown in FIG. 7 or the covering device shown in FIG. 4 or the variant embodiment shown in FIG. 2. The result is an additional advantage in terms of installation space, since the shell-like securing device 20 occupies some installation space only in the region of the second introduction point 34 of the clamping force F_{K}.

FIG. 11 shows a side view of the further, fourth variant embodiment, shown in FIG. 10, of the shell-like device for securing a high-pressure line 16 to the jacket face of the high-pressure reservoir body.

From FIG. 11, it can be seen that the ends of the upper shell 22 and lower shell 24 can be placed one inside the other and can thus form a continuous, smooth outer surface of the shell-like securing device 20. On the upper shell 22, in the variant embodiment of FIG. 11, the protrusion 84 is embodied on the inner side; it protrudes into a recess 86 in the jacket face 12 of the high-pressure reservoir body 10 and accordingly effectively prevents a relative motion between the high-pressure reservoir body 10 and the shell-like securing device 20 while the connection of the high-pressure line 16 to the high-pressure reservoir body 10 is being made. From the view in FIG. 12, a side view can be seen of the fourth variant embodiment, shown in FIG. 10, of the high-pressure connection. It can be seen from FIG. 11 that the protrusion 84, and the recess 86 cooperating with it on the jacket face 12 of the high-pressure reservoir body 10, are located above the axis of symmetry 14. Thus the lower shell 24 covers the jacket face 12 of the high-pressure reservoir body 10 over a larger wrap angle than the upper shell 22.

FIG. 12 shows a top view on the fourth variant embodiment of the high-pressure connection shown in section in FIG. 10. Both the spacer disk 92 and the conical upset part 74 located below it are covered by the upper shell 22. Reference numeral 26 marks the assembly slit, which is designed as a slitlike recess.

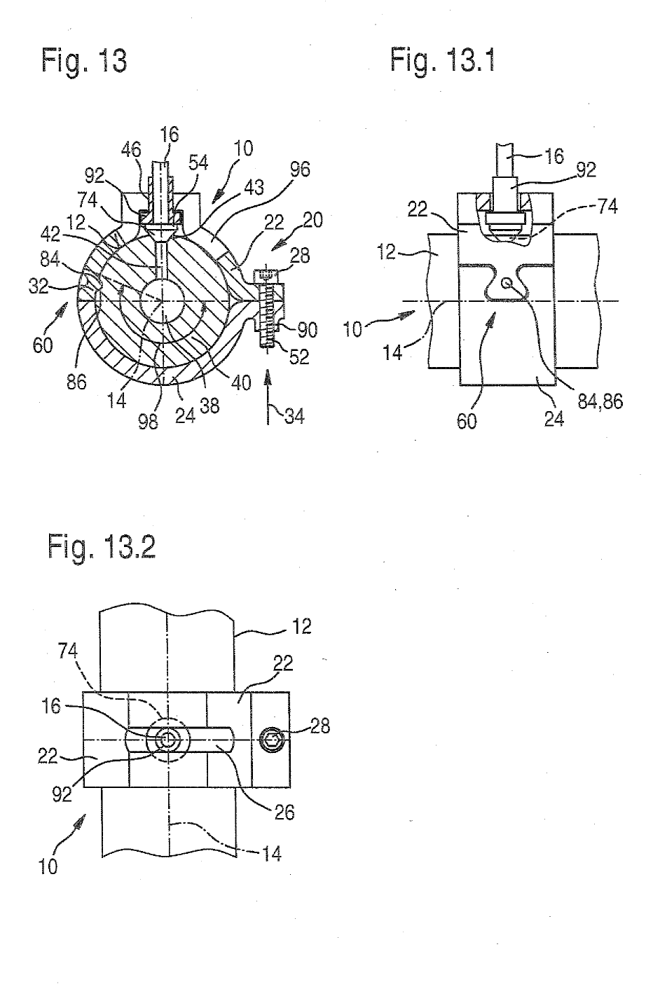

FIG. 13 shows a further variant embodiment of the connection of a high-pressure connection to a high-pressure reservoir body 10. The view in FIG. 13 is essentially equivalent to the view in FIG. 10. In a distinction from the view in FIG. 10, in FIG. 13 the wrap angle of the lower shell 24 is identified by reference numeral 98. In complementary fashion to that wrap angle, the wrap angle of the upper shell 22 of the shell-like securing device 20 is embodied as smaller. From the sectional view in FIG. 13, it can be seen that the protrusion 84 on the inside of the upper shell 22 and the recess 86, embodied complementary to it, on the jacket face 12 of the high-pressure reservoir body 10 are embodied in the region of the covering device 60; see also FIG. 13.1. The lower shell 24, which is embodied with a wrap angle of >180°—see reference numeral 98—is drawn onto the jacket face 12 of the high-pressure reservoir body 10. The upper shell 22 is pivoted into the lower shell 24 with the aid of the assembly slit 96, positioned by means of the torsion prevention means 84, 86, and suspended from the lower shell 24.

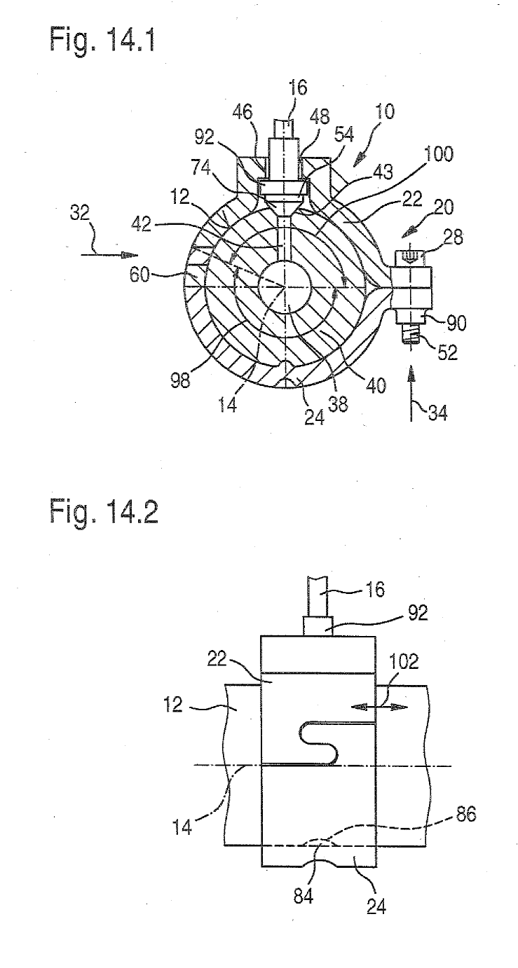

The views in FIGS. 14.1 and 14.2 show a further variant embodiment of the shell-like securing device proposed according to the invention.

From the view in FIG. 14.1, it can be seen that the upper shell 22 is embodied with a wrap angle 100 that is smaller than 180°. Correspondingly, the lower shell 24 of the shell-like securing device 20 is embodied with the wrap angle 98, which is larger than 180°. In a distinction from the half-shells 22, 24 shown in the preceding variant embodiments, the half-shells 22, 24 in the views in FIGS. 14.1 and 14.2 are displaceable axially in the joining direction 102, or in other words parallel to the axis of symmetry 14 of the high-pressure reservoir body 10. First, the lower shell 24 is drawn and axially displaced onto the jacket face 12 of the high-pressure reservoir body 10. Next, the upper shell 22 is put in place and positioned relative to the high-pressure reservoir body 10 via the high-pressure line 16. After that, the lower shell 24, by a longitudinal displacement in the direction of the double arrow 102, via locking tongues, is tangentially suspended laterally from the upper shell 22. Via the prestressing element 28, finally, the sealing force F_{D} is generated, with which the conical upset part 74 is pressed into the jacket face 12 of the high-pressure reservoir body 10.

1-10. (canceled)

11. A device for connecting a high-pressure line to a tubular high-pressure reservoir body, comprising:
at least one connection bore embodied in a wall of the high-pressure reservoir body, one end of the high-pressure line being connected to the at least one connection bore; and
a shell-like securing device surrounding the high-pressure reservoir body, the shell-like securing device embodied by two half-shells braced against one another, wherein the one end of the high-pressure line connected to the at least one connection bore is covered by one of the half-shells.

12. The device as defined by claim 11, wherein the shell-like securing device includes an upper shell and a lower shell, which are caught on one another, suspended one inside the other, or placed one inside the other at a first introduction point for a clamping force.

13. The device as defined by claim 11, wherein the half-shells are braced against one another at a second introduction point for a clamping force by means of a clamping element, or are braced on a jacket face of the high-pressure reservoir body via a clamping element-free clamp.

14. The device as defined by claim 11, further comprising a torsion prevention means embodied by at least one recess disposed on a jacket face of the high-pressure reservoir body, the at least one recess being engaged by at least one protrusion disposed on one of the half-shells.

15. The device as defined by claim 14, wherein the at least one recess and the at least one protrusion form the torsion prevention means at an arbitrary circumferential-angle position relative to the high-pressure reservoir body.

16. The device as defined by claim 12, wherein the first introduction point for the clamping force is embodied as a covering device, on which a covering end on one of the half-shells surrounds a covered end of another of the two half-shells.

17. The device as defined by claim 11, wherein the end of the high-pressure line is embodied as an upset part, a rounded upset part, or a frustoconical upset part.

18. The device as defined by claim 17, wherein the end of the high-pressure line has a shoulder, at which a sealing force of the shell-like securing device is introduced into the high-pressure line.

19. The device as defined by claim 18, wherein above the end of the high-pressure line, a spacer disk is received.

20. The device as defined by claim 18, wherein above the end of the high-pressure line, a spacer disk having a collarlike extension is received

21. The device as defined by claim 13, wherein the clamping element at the second introduction point of the clamping force is screwed into a threaded collar, wherein the threaded collar provided with a female thread.

22. The device as defined by claim 13, wherein the clamping element at the second introduction point of the clamping force is screwed into an accumulation of material in one of the half-shells.
